(19) United States
(12) Patent Application Publication
(10) Pub. No.: US 2008/0095343 A1
(43) Pub. Date: Apr. 24, 2008

(54) METHOD, SYSTEM AND CO SWITCH FOR IMPLEMENTING BILLS ASSOCIATION

(75) Inventors: Conglu CHENG, Guangdong (CN); Jinghua XU, Guangdong (CN); Fang FANG, Guangdong (CN)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Guangdong (CN)

(21) Appl. No.: 11/874,383

(22) Filed: Oct. 18, 2007

(30) Foreign Application Priority Data
Oct. 20, 2006 (CN) 200610137235.0

(51) Int. Cl. H04M 15/00

(52) U.S. Cl. 379/114.28

(57) ABSTRACT

A method for implementing bills association mainly includes generating a session identifier corresponding to a call; indicating bills with the session identifier by communication devices which are required to generate the bills corresponding to the call, to implement the association between the bills generated by the communication devices. Embodiments of the present invention further provide a system and a CO switch for implementing bills association. The method and the system of the present invention may implement the association of bills in one call. The association includes the association between ordinary bills and the association between ordinary bills and intelligent bills. In this way, telecom operators may charge a call by collecting the bill generated by each CO switch according to the Call ID to improve the precision and the efficiency of the accounting process.

### FIELD OF THE INVENTION

The present invention relates to technologies of communication accounting, and particularly, to a method, a system and a Central Office (CO) switch for implementing bills association.

### BACKGROUND OF THE INVENTION

Nowadays, telecom operators charge users mainly according to bills generated during a conversation. During the conversation, CO switches of multiple sites are usually used to charge a user for the conversation and generate bills. When the conversation is over, each of the CO switches sends the bill generated to a network accounting center. The network accounting center uniformly analyzes and processes the bill, and generates accounting information of the user. The telecom operators charge the user according to the accounting information.

A conventional telecom network is usually operated by multiple operators. An origination exchange, a termination exchange and a tandem exchange of a conversation may not be provided by one operator. Therefore, during a conversation, each site relating to the call charges for the conversation according to its own configuration, so that bills generated for a user during the conversation are saved in the origination exchange, the termination exchange and tandem exchange(s). Furthermore, because accounting modes and formats of the bills set in a CO switch of each site are different, the formats of the bills generated by each site differ from each other. It is hard to easily indicate the bills generated by each site during one conversation.

In addition, due to the constant development of technologies of the modern communication, there may be other additional services such as intelligent services in the process of a call initiated by a user. Therefore, there may be the problem that an intelligent bill generated by a device processing the intelligent services may not correspond to an ordinary bill generated by a CO switch.

### SUMMARY

Embodiments of the present invention provide a method for implementing bills association to improve the accounting precision and the accounting efficiency of the bills.

A method for implementing bills association includes:

generating a session identifier corresponding to a call; and

indicating bills corresponding to the call with the session identifier.

A system for implementing bills association includes:

a first Central Office (CO) switch, capable of generating a session identifier corresponding to a call; and

at least one second CO switch, capable of indicating a bill corresponding the call with the session identifier received from the first CO switch.

A CO switch for implementing bills association includes:

a transferring unit, capable of receiving a session identifier generated for a call; and

a processing unit, capable of obtaining the session identifier from the transferring unit, and indicating a bill with the session identifier when the processing unit is required to generate the bill corresponding to the call.

A system for implementing bills association includes:

a Service Control Point (SCP), capable of generating a session identifier corresponding to a call carrying an intelligent service, and indicating an intelligent bill generated by the SCP with the session identifier;

a Service Switch Point (SSP), capable of indicating an intelligent bill generated by the SSP with the session identifier; and

a Central Office, CO, switch, capable of triggering the SCP via the SSP after receiving the call, and indicating an ordinary bill generated with the session identifier received from the SCP via the SSP.

The technical solution provided by embodiments of the present invention generates a session identifier corresponding to a call. A communication device which is required to generate a bill corresponding to the call indicates the bill with the session identifier. The technical solution provided by embodiments of the present invention implements the association between bills generated by various communication devices by generating the session identifier and indicating the bills with the session identifier. The association includes the association between ordinary bills and the association between the ordinary bills and intelligent bills. Therefore, the solution may improve the accounting precision and the accounting efficiency of the bills.

### BRIEF DESCRIPTION OF THE DRAWINGS

FIG. 1 is a simplified flowchart of a method according to a first embodiment of the present invention.

FIG. 2 is a schematic diagram illustrating the structure of a system according to the first embodiment of the present invention.

FIG. 3 is a schematic diagram illustrating the structure of a CO switch according to the first embodiment of the present invention.

FIG. 4 is a simplified flowchart of a method according to a second embodiment of the present invention.

FIG. 5 is a schematic diagram illustrating the structure of a system according to the second embodiment of the present invention.

### DETAILED DESCRIPTION OF THE INVENTION

The technical solution provided by embodiments of the present invention generates a session identifier corresponding to a call. A communication device which is required to generate a bill corresponding to the call indicates the bill to be generated with the session identifier to implement the association between bills generated by various communication devices. The association includes the association between ordinary bills and the association between the ordinary bills and intelligent bills.

Embodiments of the present invention mainly include two aspects. 1) Devices which are required to generate bills indicate the bills with an exclusive Call ID to implement the association of the bills generated during one conversation. The devices include a CO switch providing ordinary services and a device handling intelligent services. 2) When there is an intelligent service in the conversation, the CO switch triggers an intelligent service to implement the association between ordinary bills generated by the CO switch and intelligent bills generated by the device processing the intelligent service. In the embodiments of the present invention, the session identifier may be the Call ID.

In an intelligent service, a Service Switch Point (SSP) is a connection point between a calling network and an intelligent network. The SSP provides the function of accessing an intelligent network function set. After receiving a request of a CO switch for triggering an intelligent service, the SSP communicates with a Service Control Point (SCP) and responds to the request of the SCP to allow the service logic in the SCP to process the call. The SCP initiates different service logics based on different call events reported by the SSP and sends a call control instruction to the corresponding SSP according to the service logics to indicate the SSP to perform some next action. Therefore, all types of intelligent calls are implemented. The SCP communicates with the SSP according to the Intelligent Network Application Protocol (INAP).

Embodiments of the present invention are further described in detail with reference to the accompanying drawings.

### The First Embodiment

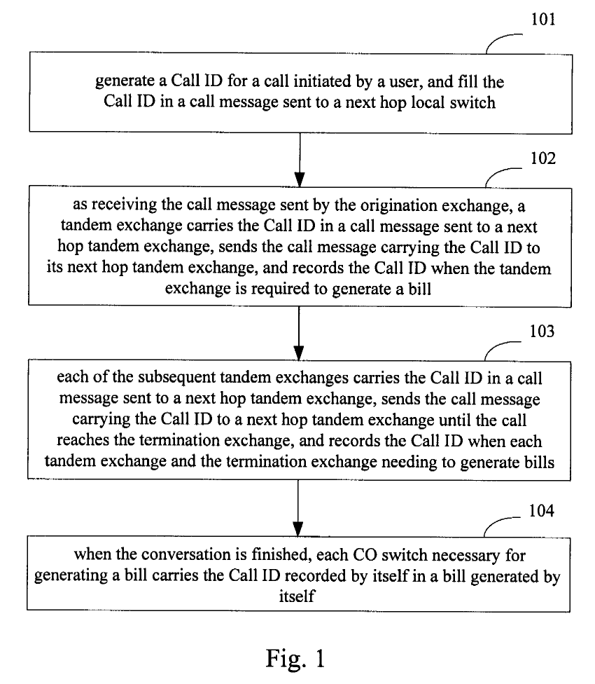

In this embodiment, it is supposed that a call initiated by a user does not carry an intelligent service, and merely carries an ordinary service. As shown in FIG. 1, here is a simplified flowchart of a method in accordance with the first embodiment.

Block 101: As receiving a call initiated by a local user, a CO switch generates a Call ID for the call, fills the Call ID in a call message to be sent to a next hop CO switch, and sends the call message with the Call ID to the next hop CO switch. The call message may be the User Part of Integrated Service Digital Network (ISUP) or Session Initiation Protocol for Telephones (SIP-T) type.

The Call ID may be defined according to the information unit structure of the Network call reference defined by the International Telecommunications Union Telecommunication Standardization Sector (ITU-T) Q.763 protocol standard, and be filled into the call message.

When the origination exchange needs to generate a bill, the generated Call ID may be saved. The origination exchange may be the CO switch.

Block 102: As receiving the call message sent by the origination exchange, a tandem exchange which is located as the next hop CO switch of the call, handles the call. The tandem exchange carries the Call ID in a call message to be sent to a next hop tandem exchange, and sends the call message to the next hop tandem exchange. When the tandem exchange is required to generate a bill, the Call ID may be saved.

Block 103: Each of the subsequent tandem exchanges relating to the call carries the Call ID in a call message to be sent to a next hop tandem exchange, and sends the call message to the next hop tandem exchange until the call reaches the termination exchange. The Call ID may be saved by each of the tandem exchanges or the termination exchange which is required to generate bills.

Block 104: As the call is finished, each CO switch which is required to generate a bill may carry the Call ID in the bill generated by the CO switch.

During the call period, all sites which are required to generate bills fill a uniform Call ID into bills generated by the sites to implement the consistency of the bills generated by all sites during the call. When each site sends the bill generated by itself to a network accounting center, the network accounting center may search bills corresponding to the call generated by each of the sites according to the Call ID.

For some special accounting strategies, the origination exchange is not required to generate a bill. As in this embodiment, the Call ID is not limited to be generated by the origination exchange, and may be generated by a first tandem exchange which is required to generate a bill for the call.

As receiving the call initiated by the local user or inputted via the tandem exchange, the CO switch which is required to generate a bill detects whether the call message carries a Call ID. If the call message does not carry a Call ID, the CO switch generates a Call ID, and fills the generated Call ID into a call message to be sent to a next hop CO switch.

The CO switch generating the Call ID may be a CO switch which receives a call message not carrying a Call ID. If the Call ID is lost due to the device failure, the Call ID may be generated. So, bills generated may be indicated with the Call ID, and the association of the bills may be implemented.

In this embodiment, the call initiated by a user merely includes ordinary services and not includes intelligent services. The bills generated by the CO switch in processing the ordinary services are named as ordinary bills.

When a call initiated by a user also includes an intelligent service, the CO switch sends a Call ID which is corresponding to the call to the SCP via the SSP while triggering the SCP to provide intelligent service for the user. The SCP and the SSP fill the Call ID in intelligent bills corresponding to the intelligent service according to their configuration when they are required to generate the intelligent bills. When the SCP is merely required to generate an intelligent bill, it indicates the intelligent bill with the Call ID. The CO switch may also fill the Call ID in an ordinary bill generated by itself The association of ordinary bills of various sites and the association between ordinary bills and intelligent bills during one call may be implemented.

When the CO switch is required to trigger an intelligent service and not to generate an ordinary bill according to the received call message, and if the call message does not carry a Call ID, the CO switch generates a Call ID, and sends the Call ID to the SCP via the SSP. When the SSP and the SCP are required to generate intelligent bills, they indicate the intelligent bills with the Call ID. When the SCP is merely required to generate an intelligent bill, it indicates the intelligent bill with the Call ID. When a subsequent CO switch of the call is required to generate an ordinary bill, the CO switch indicates the ordinary bill generated by itself with the Call ID.

In addition, embodiments of the present invention further provide a system for implementing bills association. The system includes a first CO switch and at least one second CO switch. The first CO switch is used for generating a session identifier corresponding to the current call and sending the session identifier. The second CO switch is used for receiving the session identifier, and indicating a bill to be generated with the session identifier when it is required to generate the bill corresponding to the call. Wherein, the first CO switch is further used for indicating the bill to be generated with the session identifier when the first CO switch generates the bill corresponding to the call.

The system may include at least one third CO switch. The third CO switch is used for transferring the session identifier between the first CO switch and the second CO switch, between the first CO switch and another third CO switch, between two second CO switches, between two other third CO switches, or between the second CO switch and another third CO switch.

The system may include a Service Switch Point (SSP) and a Service Control Point (SCP). At least one of the first CO switch, the second CO switch and the third CO switch is further used for sending the session identifier to the SCP via the SSP as detecting that an intelligent service is included in the current call. When the SSP and the SCP are required to generate intelligent bills, they are used for indicating the intelligent bills with the session identifier received from the CO switch. When the SCP is merely required to generate an intelligent bill, it indicates the intelligent bill with the session identifier received from the CO switch.

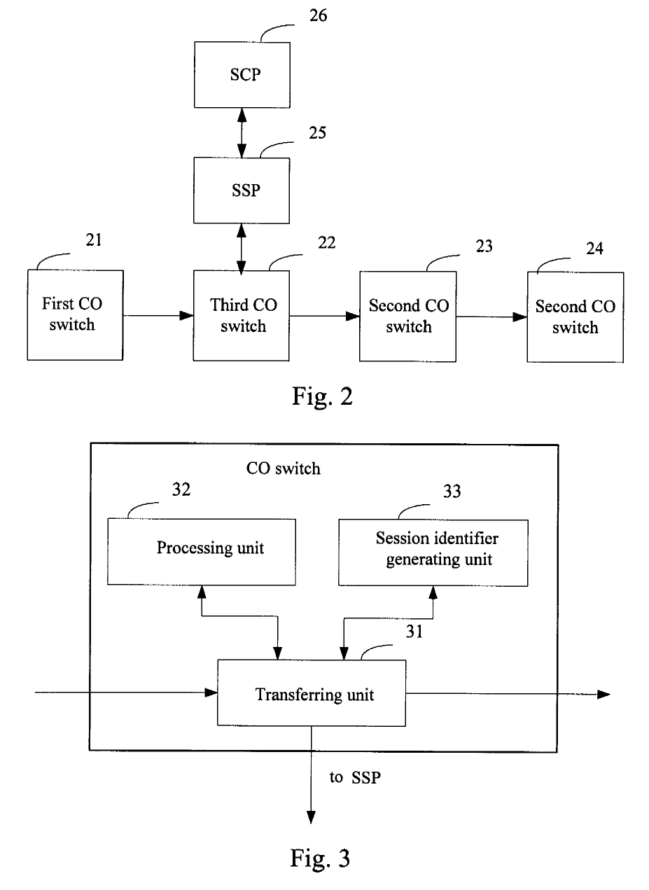

FIG. 2 is a schematic diagram illustrating the structure of a system according to a first embodiment of the present invention. The system consists of a first CO switch 21, a third CO switch 22, second CO switches 23 and 24, an SSP 25 and an SCP 26. In FIG. 2, the first CO switch 21, acting as the origination exchange of the current call, generates a session identifier corresponding to the current call, and sends the session identifier to the third CO switch 22. As detecting that the current call includes an intelligent service, the third CO switch 22 sends the received session identifier to the SCP via the SSP, and sends the received session identifier to the second CO switch 23. The second CO switch 23 needs to generate a bill for the current call, saves the session identifier which is sent from the first CO switch 21 via the third CO switch 22, indicates the bill with the session identifier upon generating the bill corresponding to the current call, and sends the received session identifier to the second CO switch 24. The second CO switch 24, acting as the termination exchange of the current call and the CO switch which is also required to generate a bill, saves the received session identifier, and indicates the bill with the session identifier upon generating the bill corresponding to the current call. In addition, The SSP 25 and the SCP 26 indicate intelligent bills generated by themselves with the session identifier received from the third CO switch 22 respectively, or the SCP 26 indicates an intelligent bill generated by itself with the session identifier received front the third CO switch 22. The structure of the system as shown in FIG. 2 is merely a specific implementation of the system, which is not used to limit the technical solution provided by embodiments of the present invention.

At least two CO switches of the first CO switch, the second CO switch, and the third CO switch described in this embodiment all may be the same CO switch, for example, a CO switch may be used as the first CO switch and the second CO switch at the same time.

Referring to FIG. 3, embodiments of the present invention provide a CO switch for implementing bills association. The CO switch includes a transferring unit 31 and a processing unit 32. The transferring unit 31 is used for receiving a session identifier generated for the current call. The processing unit 32 is used for obtaining the session identifier from the transferring unit 31 and indicating a bill by the session identifier when the CO switch is required to generate the bill corresponding to the current call.

In addition, the CO switch further includes a session identifier generating unit 33. The session identifier generating unit 33 is used for generating the session identifier for the current call, and sending out the generated session identifier as required. Correspondingly, the transferring unit 31 receives the session identifier sent by the session identifier generating unit 33, or receives the session identifier sent by a previous hop CO switch.

When the current CO switch is not the termination exchange of the current call, the transferring unit 31 is further used for sending the received session identifier to a next hop CO switch of the call.

In embodiments of the present invention, the transferring unit 31 may send the session identifier in a call message corresponding to the current call. In actual application, the session identifier is carried in a call message which is sent out by the transferring unit 31 for the first time. Furthermore, if the transferring unit 31 may not find the call message corresponding to the current call, i.e. the transferring unit 31 may not obtain the session identifier from the call message corresponding to the current call, the transferring unit 31 indicates the session identifier generating unit 33 to generate the session identifier corresponding to the current call. Correspondingly, the session identifier generating unit 33 generates the session identifier corresponding to the current call according to the indication of the transferring unit 31. In addition, after detecting that an intelligent service is included in the current call, the transferring unit 31 sends the session identifier to the SCP via the SSP according to the received call message.

### The Second Embodiment

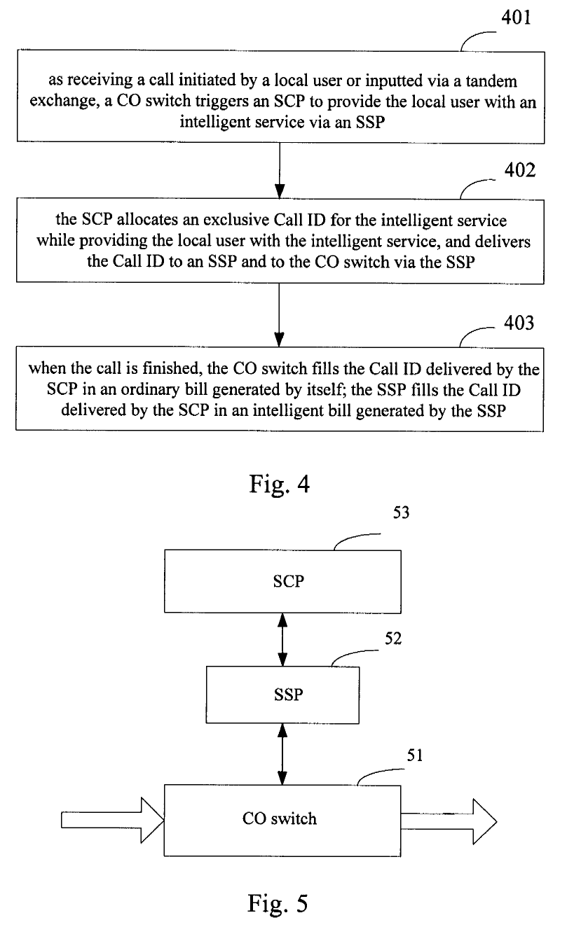

FIG. 4 is a simplified flowchart of a method according to a second embodiment of the present invention. In this embodiment, an SSP and an SCP both are supposed to generate intelligent bills.

Block 401: As receiving a call initiated by a local user or inputted via a tandem exchange, a CO switch triggers the SCP to provide the local user with an intelligent service via the SSP when the CO switch detects that the intelligent service is required to be triggered according to the call.

Block 402: The SCP generates an exclusive Call ID for the intelligent service while providing the intelligent service for the local user, and delivers the Call ID to the CO switch via the SSP and to the SSP.

The manner for the SCP delivering the Call ID may be: the SCP inserts a private field in an Intelligent Network Application Protocol (INAP) message, fills the current allocated Call ID in the inserted private field, and sends the INAP message within the Call ID to the SSP. The SSP transmits the INAP message to the CO switch.

Block 403: When the intelligent service of the call is finished, if the SCP is required to generate the intelligent bill, the SCP fills the generated Call ID in an intelligent bill generated by the SCP. The SSP fills the Call ID delivered by the SCP in an intelligent bill generated by the SSP when the SSP is required to generate the intelligent bill. As the call is finished, the CO switch fills the Call ID delivered by the SCP in an ordinary bill generated by the CO switch.

In the embodiment of the present invention, it should be noted that the SCP may generate an intelligent bill, and the SSP may not generate an intelligent bill. In this way, merely the SCP is required to fill the generated Call ID in the intelligent bill generated by the SCP.

FIG. 5 is a schematic diagram illustrating the structure of a system according to the second embodiment of the present invention. The system consists of a CO switch 51, an SSP 52 and an SCP 53.

As receiving a call within an intelligent service, the CO switch 51 is used for triggering the SCP 53 to handle the intelligent service via the SSP 52, and indicating an ordinary bill with a received session identifier when the CO switch 51 is required to generate the ordinary bill. The SCP 53 is used for handling the intelligent service within the current call, generating the session identifier corresponding to the call, and sending the session identifier to the CO switch 51 via the SSP 52. The SCP 53 may further include a session identifier generating unit for generating the session identifier corresponding to the call upon processing the current intelligent service, and sending the session identifier to the CO switch 51 via the SSP 52. The SCP 53 is used for indicating an intelligent bill generated by the SCP 53 with the session identifier, and the SSP 52 may be also used for indicating an intelligent bill generated by the SSP 52 with the session identifier.

In addition, the SCP 53 sends an INAP message carrying the session identifier to the CO switch 51 via the SSP 52.

In the embodiments of present invention, the SSP 52 may also be located in the CO switch 51, and the processing procedure mentioned above in the embodiment is also suitable for the case that the SSP 52 is located at the CO switch 51.

If the CO switch of the call initiated by a user is required to trigger the SCP to handle multiple intelligent services, as bills of each intelligent service are generated in the SCP and the SSP, or merely generated in the SCP corresponding to each intelligent service, the SCP can generates a Call ID and delivers the Call ID to the CO switch via the SSP when the SCP handles the first intelligent service of the current call. The SSP and the SCP fill the Call ID in multiple intelligent bills generated for the current call when the SCP and the SSP both are required to generate the intelligent bills, or merely the SCP fills the Call ID in an intelligent bill generated for the current call when the SCP is required to generate the intelligent bill. And the CO switch may also fill the Call ID sent from the SCP in the ordinary bill generated for the call by the CO switch.

Whether the SSP or SCP is required to generate bills is determined by telecom operators according to the requirement of the whole network. So the SSP and SCP may not perform the processing of filling the Call ID in bills when they are not required to generate bills.

In this embodiment, the association between an ordinary bill generated by each CO switch of each site and an intelligent bill of a triggered intelligent service generated by at least one of the SCP and the SSP in one call process, is implemented by filling the Call ID generated by the SCP in the ordinary bill generated by the CO switch and the intelligent bill generated by at least one of the SCP and the SSP. During the accounting process, it is possible to easily find out an ordinary bill generated by one site and an intelligent bill of the intelligent service triggered by the site during a call process including an intelligent service according to the Call ID.

The technical solution provided by embodiments of the present invention mainly generates a session identifier corresponding to a call and enables a communication device which is required to generate a bill corresponding to the call to indicate the bill to be generated with the generated session identifier to implement the association between the bills generated by various communication devices. In this way, the telecom operators may charge the conversation by collecting bills according to the Call ID, the bills are generated by each CO switch, SSP, or SCP. So the precision and the efficiency of the accounting process may be improved.

The foregoing are only preferred embodiments of the present invention and are not for use in limiting the protection scope thereof. All the modifications, equivalent replacements or improvements in the scope of the present invention's sprit and principles shall be included in the protection scope of the present invention.

1. A method for implementing bills association, comprising:
generating a session identifier corresponding to a call; and
indicating bills corresponding to the call with the session identifier.

2. The method of claim 1, wherein generating a session identifier corresponding to a call comprises:
generating the session identifier corresponding to the call by a Central Office (CO) switch of an origination exchange initiating the call.

3. The method of claim 1, wherein generating a session identifier corresponding to a call comprises:
generating the session identifier corresponding to the call by a CO switch which is required to generate a bill corresponding to the call when the session identifier is not obtained.

4. The method of claim 1, wherein
indicating bills corresponding to the call with the session identifier comprises:
indicating one of the bills with the session identifier by a CO switch which is required to generate the bill corresponding to the call.

5. The method of claim 4, further comprising:
sending the session identifier to a Service Control Point (SCP), via a Service Switch Point (SSP), upon triggering an intelligent service carried in the call; wherein
indicating bills corresponding to the call with the session identifier further comprises:
indicating an intelligent bill generated with the session identifier by the SCP.

6. The method of claim 1, further comprising:
triggering an SCP via an SSP by a CO switch after receiving a call carrying an intelligent service; and
sending the session identifier to the CO switch via the SSP by the SCP; wherein
generating the session identifier corresponding to the call comprises: generating the session identifier corresponding to the call by the SCP;
indicating bills corresponding to the call with the session identifier comprises: indicating an intelligent bill with the session identifier by the SCP, indicating an ordinary bill with the session identifier by the CO switch.

7. The method of claim 6, further comprising:
filling the session identifier in an Intelligent Network Application Protocol (INAP) message; wherein
sending the session identifier to the CO switch via the SSP by the SCP comprises: sending the INAP message carrying the session identifier to the CO switch via the SSP by the SCP.

8. The method of claim 6, wherein
the session identifier is generated for the first intelligent service by the SCP when the SCP is triggered to handle multiple intelligent services.

9. The method of claim 5, wherein
indicating bills corresponding to the call with the session identifier further comprises:
indicating an intelligent bill generated with the session identifier by the SSP.

10. The method of claim 6, wherein
indicating bills corresponding to the call with the session identifier further comprises: indicating an intelligent bill with the session identifier by the SSP.

11. A system for implementing bills association, comprising:
a first Central Office (CO) switch, capable of generating a session identifier corresponding to a call; and
at least one second CO switch, capable of indicating a bill corresponding the call with the session identifier received from the first CO switch.

12. The system of claim 11, further comprising at least one third CO switch; wherein
at least two CO switches of the first CO switch, the second CO switch, and the third CO switch are the same CO switch.

13. The system of claim 11, wherein the first CO switch is further capable of indicating a bill with the session identifier upon generating the bill corresponding to the call.

14. The system of claim 12, further comprising: a Service Control Point (SCP); wherein
at least one of the first CO switch, the second CO switch and the third CO switch is further capable of sending the session identifier to the SCP via a Service Switch Point (SSP) as detecting that an intelligent service is carried in the call; and
the SCP is capable of indicating an intelligent bill generated by the SCP with the session identifier.

15. The system of claim 14, wherein
the SSP is capable of indicating an intelligent bill generated by the SSP with the session identifier.

16. A Central Office, CO, switch for implementing bills association, comprising:
a transferring unit, capable of receiving a session identifier generated for a call; and
a processing unit, capable of obtaining the session identifier from the transferring unit, and indicating a bill with the session identifier when the processing unit is required to generate the bill corresponding to the call.

17. The CO switch of claim 16, further comprising:
a session identifier generating unit, capable of generating the session identifier for the call; wherein
the transferring unit is further capable of receiving the session identifier from the session identifier generating unit.

18. The CO switch of claim 16, wherein the transferring unit is further capable of receiving the session identifier from a previous hop CO switch of the call.

19. The CO switch of claim 16, wherein the transferring unit is further capable of sending the session identifier to a next hop CO switch of the call.

20. The CO switch of claim 19, wherein the transferring unit sends the session identifier which is carried in a call message corresponding to the call.

21. The CO switch of claim 17, wherein
the transferring unit is further capable of indicating the session identifier generating unit to generate the session identifier corresponding to the call when the session identifier is not obtained; and
the session identifier generating unit is further capable of generating the session identifier corresponding to the call according to the indication of the transferring unit.

22. The CO switch of claim 20, wherein the transferring unit is further capable of sending the session identifier to a Service Control Point (SCP) via a Service Switch Point (SSP) according to the call message as detecting that an intelligent service is carried in the call.

23. A system for implementing bills association, comprising:
a Service Control Point (SCP), capable of generating a session identifier corresponding to a call carrying an intelligent service, and indicating an intelligent bill generated by the SCP with the session identifier;
a Service Switch Point (SSP), capable of indicating an intelligent bill generated by the SSP with the session identifier; and
a Central Office, CO, switch, capable of triggering the SCP via the SSP after receiving the call, and indicating an ordinary bill generated with the session identifier received from the SCP via the SSP.

24. The system of claim 23, wherein the SCP is further capable of sending an Intelligent Network Application Protocol (INAP) message carrying the session identifier to the CO switch via the SSP.
